(19) United States
(12) Patent Application Publication
(10) Pub. No.: US 2015/0137759 A1
(43) Pub. Date: May 21, 2015

(54) Automated Mobile Device Battery Charging Kiosks

(71) Applicant: MobileQubes, LLC, New Orleans, LA (US)

(72) Inventors: Jason Palmer, New Orleans, LA (US); Sean Carrigan, New Orleans, LA (US); Michael Hoggart, San Diego, CA (US); Murray Learmonth, San Diego, CA (US)

(21) Appl. No.: 14/466,761

(22) Filed: Aug. 22, 2014

Related U.S. Application Data
(60) Provisional application No. 61/869,043, filed on Aug. 22, 2013.

(51) Int. Cl. H02J 7/00

(52) U.S. Cl. CPC H02J 7/0013; H02J 7/0044
USPC 320/112

(57) ABSTRACT

The present invention relates to apparatuses and methods for charging mobile devices. More particularly, the present invention relates to a charging station where individuals, who are in need of charging their mobile devices but do not have access to a personal charger, can charge their devices for a small fee without requiring them to be tethered to an unprotected charging cord or electrical outlet.

### CROSS-REFERENCE TO RELATED APPLICATIONS

This application claims priority of U.S. Provisional Patent Application No. 61/869,043, filed 22 Aug. 2013, which is hereby incorporated by reference.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to apparatuses and methods for charging mobile devices. More particularly, the present invention relates to a charging station where individuals, who are in need of charging their mobile devices but do not have access to a personal charger, can charge their devices for a small fee without requiring them to be tethered to an unprotected charging cord or electrical outlet.

2. General Background of the Invention

The present invention relates to apparatuses and methods for charging mobile devices. More particularly, the present invention relates to a charging station where individuals, who are in need of charging their mobile devices but do not have access to a personal charger, can charge their devices for a small fee without requiring them to be tethered to an unprotected charging cord or electrical outlet.

In general, owners of mobile devices are limited by the battery life of said devices in that owners must be constantly aware of level of charge when operating the device off the battery. During times when the needed level of usage exceeds the capacity of the device's battery, an individual must normally carry recharging elements such as charging cables that can connect with electrical outlets. Unfortunately, finding electrical outlets in high traffic areas such as airports and convention centers is normally very difficult. Also if an electrical outlet is available, an individual is required to stay with the device as it is recharging. Finally if the individual forgets to bring their recharging element, then recharging their mobile device may be impossible if they are unable to find a replacement recharging element.

Patents have issued on various forms of battery dispensing apparatuses and mobile charging devices. Examples can be found in the following table, each of which is incorporated herein by reference.

TABLE 1

| | | ISSUE DATE |
|---|---|---|
| PAT. NO. | TITLE | (MM-DD-YYYY) |
| 5,544,784 | RECHARGEABLE BATTERY | 08-13-1996 |
| | VENDING MACHINE | |
| 7,723,951 | BATTERY CHARGING APPARATUS | 05-25-2010 |
| | HAVING A CHUTE AND METHOD | |
| | OF RECHARGING A BATTERY | |
| 8,098,046 | BATTERY CHARGING APPARATUS | 01-17-2012 |
| | HAVING A CHUTE AND METHOD | |
| | OF RECHARGING A BATTERY | |

U.S. Pat. No. 5,544,784 to Malaspina discloses a vending machine for vending a rechargeable battery pack that can receive payment and generate payment information. The vending machine further includes a selection entry means for generating selection information, a battery pack storage space, and a means for dispensing said rechargeable battery pack. The vending machine comprises of a control unit having a memory, battery pack receiver unit, battery pack, test unit, recharging unit, and a battery pack handling mechanism. The vending machine may further comprise of a money handling unit, interface unit, and a dispensing unit.

U.S. Pat. Nos. 7,723,951 and 8,098,046 to Poisner discloses a battery charging apparatus with a housing that has an enclosed chute running through a central axis of the housing. The chute is configured to receive a battery via an insertion slot and configured to dispense a battery through a dispensing slot. Within the housing, charging terminals are disposed to come in contact with charging terminal on the batteries inserted into the housing. The apparatus may include solenoid-controlled gates to monitor the insertion of the batteries or radio-frequency identification tag readers to permit inventorying and tracking of batteries.

A handful of entities such as Brightbox, Lastcall Chargers, NV3 Technologies, & GoCharge are attempting to solve the same problem by using kiosks with lockable boxes that hold and charge mobile devices. Yet, this problem remains unresolved.

### BRIEF SUMMARY OF THE INVENTION

The present invention relates to apparatuses and methods for charging mobile devices. More particularly, the present invention relates to a charging station where individuals, who are in need of charging their mobile devices but do not have access to a personal charger, can charge their devices for a small fee without requiring them to be tethered to an unprotected charging cord or electrical outlet. The apparatus and methods generally includes: a battery pack; a kiosk; a battery pack apparatus for receiving, storing, charging, and dispensing, said battery pack, and kiosk software. The battery pack is preferably adapted for general use on a broad range of mobile devices. The battery pack apparatus is preferably adapted for receiving, storing, charging, and dispensing, a battery pack or a plurality of battery packs. The kiosk is preferably adapted to include an interface with means to preferably allow an individual to initiate a transaction for acquiring a battery pack, submit financial information to acquire said battery pack, complete a transaction wherein the individual can preferably receive a battery pack or return a battery pack to the battery pack apparatus, or disclose information to the individual regarding the transaction. The battery pack apparatus is preferably located within the kiosk. The kiosk software is preferably adapted with an architecture allowing for coordination between the battery pack, the battery pack apparatus, and the kiosk. An embodiment of the invention includes placing the kiosk in high traffic locations where potential customers find themselves in need of charging their mobile devices, but do not have access to a personal charger. This embodiment enables customers to charge their devices for a small fee, without requiring them to be tethered to an unprotected charging cord or electrical outlet.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a perspective view of a preferred embodiment of the kiosk of the present invention;

FIG. 2 is a side view of a preferred embodiment of the kiosk of the present invention;

FIG. 3 is a front view of a preferred embodiment of the kiosk of the present invention;

FIG. 4 is a back view of a preferred embodiment of the kiosk of the present invention;

FIG. 5 is a perspective close up view of a preferred embodiment of the kiosk of the present invention;

FIG. 6 is a side view of a preferred embodiment of the battery pack of the present invention;

FIG. 7 is a perspective view of a preferred embodiment of the battery pack of the present invention;

FIG. 8 is a close up perspective view of a preferred embodiment of the battery pack assembly of the present invention;

FIG. 9 is a perspective view of a preferred embodiment of the battery pack assembly of the present invention;

FIGS. 10-13 are close up side views of a preferred embodiment of the battery pack release mechanism of the present invention during various stages of battery pack release;

FIG. 14 is a close up perspective view of a preferred embodiment of the carriage assembly of the present invention; and

FIG. 15 is a close of view of a preferred embodiment of the Cam Bias Charging Plate Mechanism of the present invention.

### DETAILED DESCRIPTION OF THE INVENTION

The present invention relates to apparatuses and methods for charging mobile devices. More particularly, the present invention relates to a charging station where individuals, who are in need of charging their mobile devices but do not have access to a personal charger, can charge their devices for a small fee without requiring them to be tethered to an unprotected charging cord or electrical outlet. The apparatus and methods generally includes: a battery pack (200); a kiosk (100); a battery pack apparatus (300) for receiving, storing, charging, and dispensing, said battery pack (200), and kiosk software. The battery pack (200) is preferably adapted for general use on a broad range of mobile devices. The battery pack apparatus (300) is preferably adapted for receiving, storing, charging, and dispensing, a battery pack (200) or a plurality of battery packs (200). The kiosk (100) is preferably adapted to include an interface with means to preferably allow an individual to initiate a transaction for acquiring a battery pack (200), submit financial information to acquire said battery pack (200), complete a transaction wherein the individual can preferably receive a battery pack (200) or return a battery pack (200) to the battery pack apparatus (300), or disclose information to the individual regarding the transaction. The battery pack apparatus (300) is preferably located within the kiosk (100). The kiosk software is preferably adapted with an architecture allowing for coordination between the battery pack (200), the battery pack apparatus (300), and the kiosk (100). An embodiment of the invention includes placing the kiosk (100) in high traffic locations where potential customers find themselves in need of charging their mobile devices, but do not have access to a personal charger. This embodiment enables customers to charge their devices for a small fee, without requiring them to be tethered to an unprotected charging cord or electrical outlet.

The battery pack (200) is preferably a lithium ion or lithium polymer battery cell with a preferably capacity of 3000-10,000 Milliamps Hour (mAh). The battery pack (200) has a preferably size range of 1,100 to 2,200 mAh/cubic inch. The battery pack (200) may be of any suitable size. In a preferred embodiment, the battery pack (200) is 63 millimeters by 45 millimeters by 22 millimeters with rounded corners. The preferable output of said battery pack (200) is 5 volts (V) at 1 ampere (A) for Apple 30 pin (220) and Apple Lightning Connector. The preferred output for Standard USB Female and MicroUSB is 5 volts (V) at 2.1 ampere (A). In a preferred embodiment, the input of all battery packs (200) is 5 volts (V) at 1 ampere (A). Power inputs such as charging pads and female MicroUSB inputs (210) for recharging the battery pack (200) are preferably located on the side of battery pack (200). The battery pack (200) is preferably adapted for general use on a broad range of mobile devices. For use on mobile devices, the battery pack (200) preferably includes a broad range of connection to said mobile devices such as an Apple 30pin Connector (220), an Apple Lightning Connector, MicroUSB, or a Standard USB Female connection. Each battery pack (200) preferably includes a means for identification such as a barcode or a passive radio-frequency identification (RFID) tag (222). The passive RFID tag (222) is preferably of a 24.5 millimeter diameter located inside the battery pack's cover. Two passive RFID tags (222) are located on either face of the battery pack (200). This ensures that the battery pack (200) will be scanned properly regardless of orientation. Additionally, a dielectric material (tape, epoxy, sheet, etc. . . . ) (224) is placed internally between the passive RFID tag (222) and battery cell. The dielectric layer (224) serves to insulate the RFID (222) from the conductive lithium polymer or lithium ion battery cell. The shape of the battery pack (200) is preferably cube shaped pack with rounded corners, oval/pill shaped, or cylindrical with integrated protection. The battery pack (200) preferably is adapted to include recharging means that allows for recharging of said battery pack (200) regardless of orientation the power inputs when inserted into the kiosk (100). The battery pack (200) preferably includes safety features. Such safety features are preferably included within the device in order to gain approval of regulatory agencies such as IEEE 1725, NEMA C18.2M, Part 2. An embodiment of invention includes that the battery pack (200) is color coded for disseminating the type of connection associated with said battery pack (200).

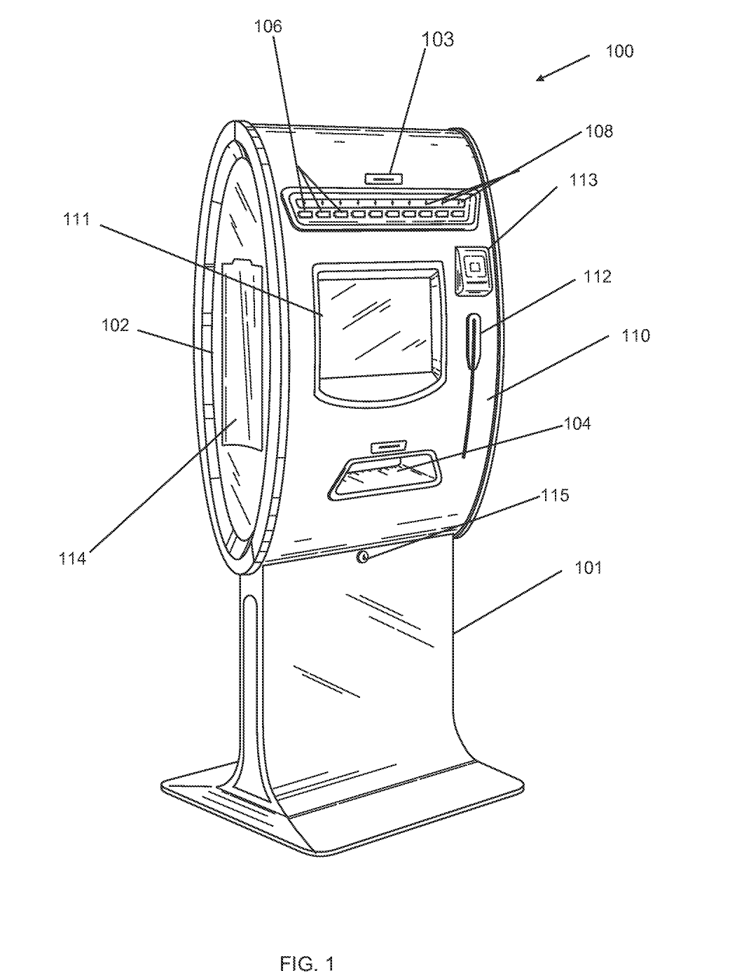

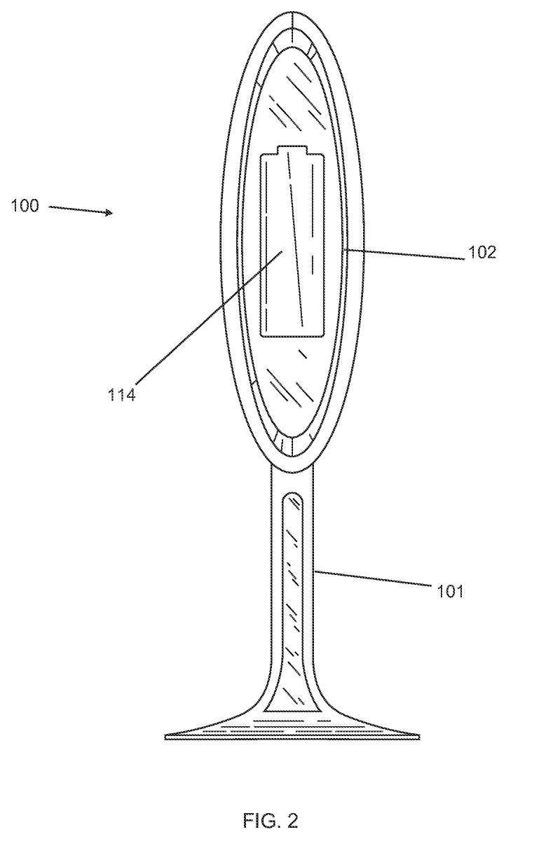

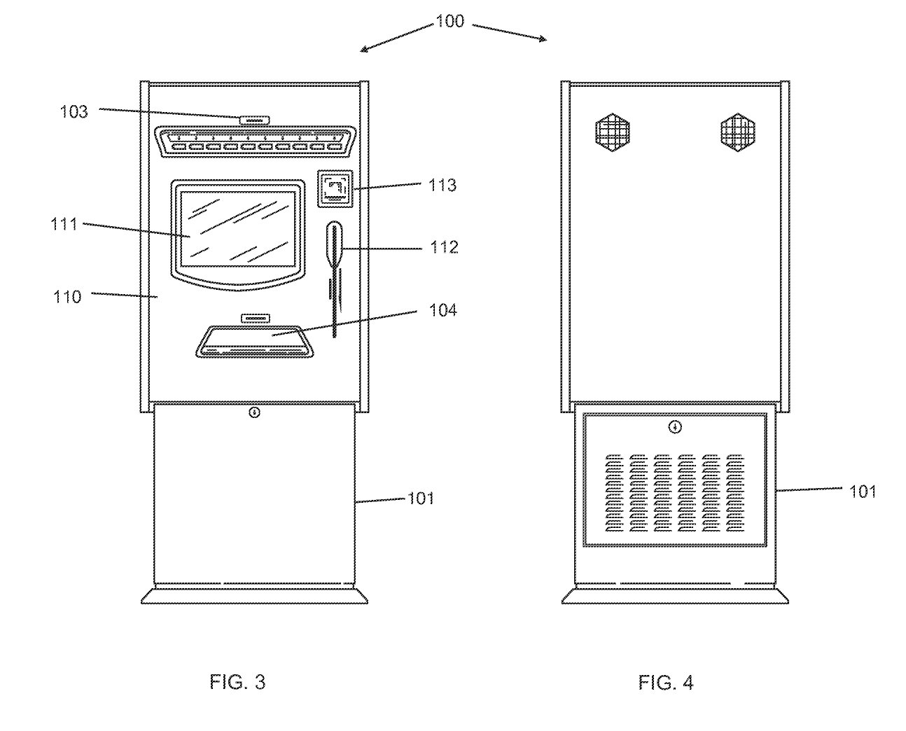

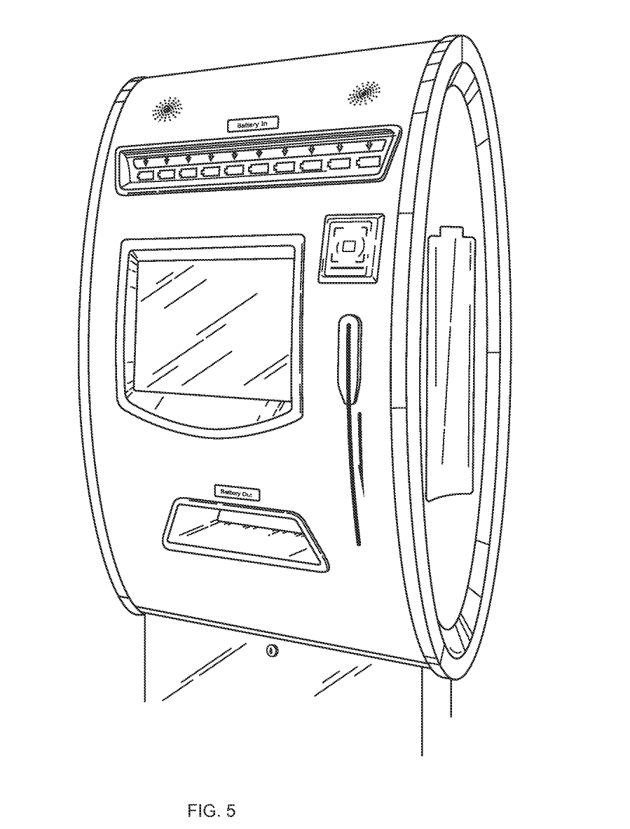

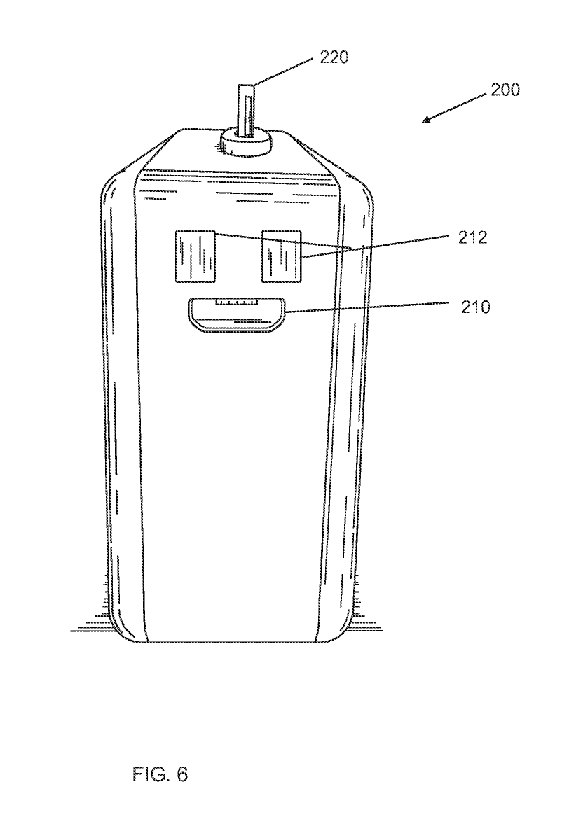

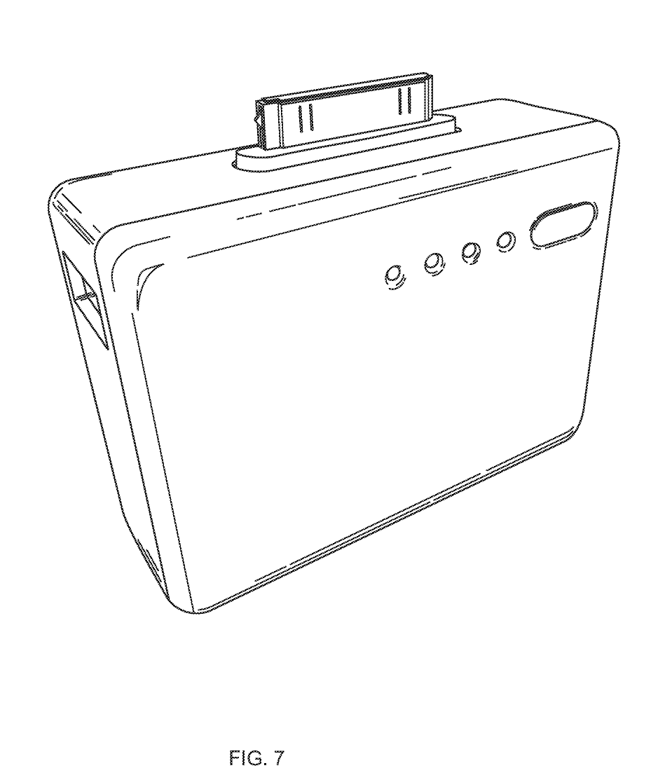

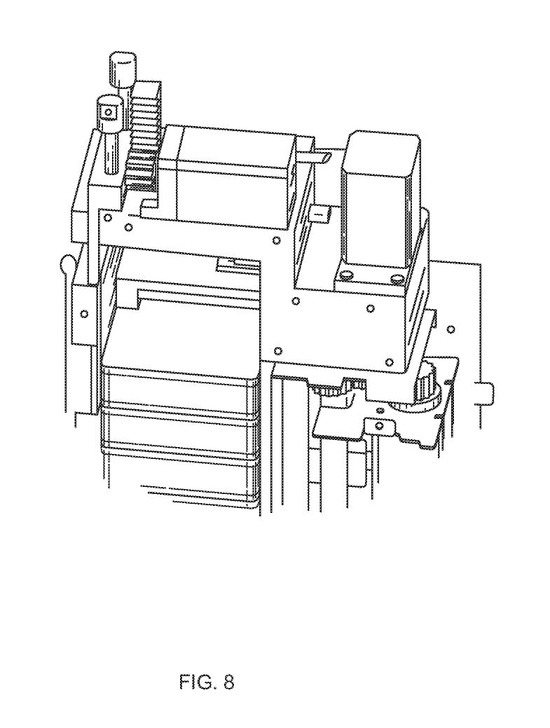

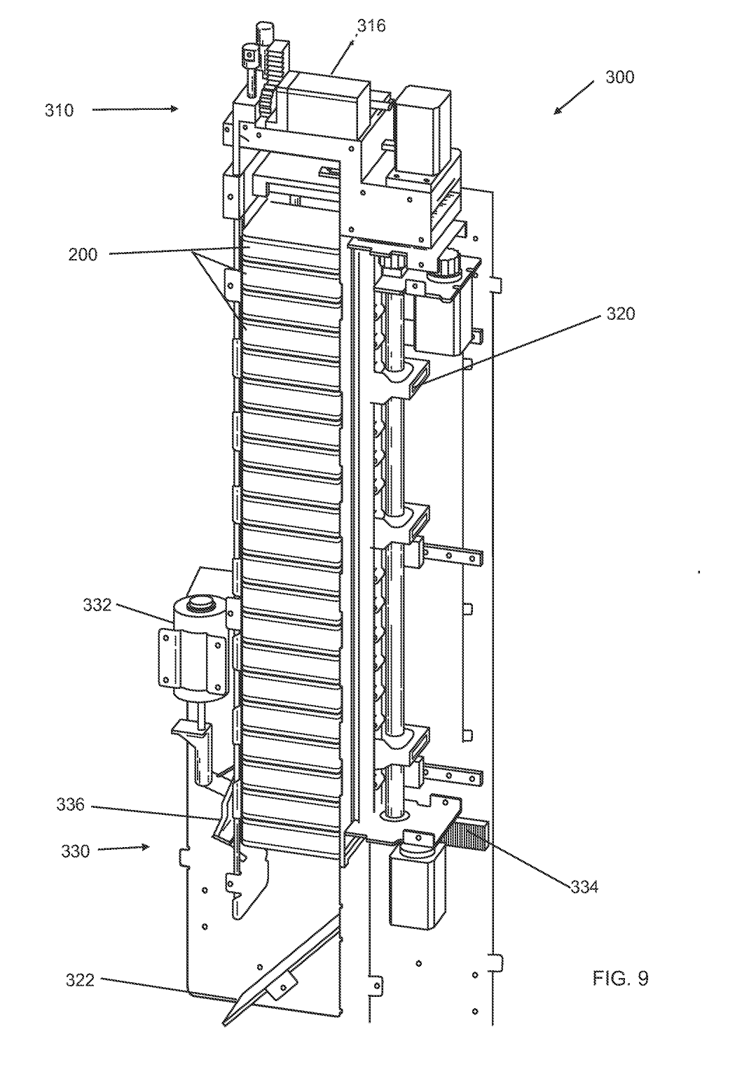

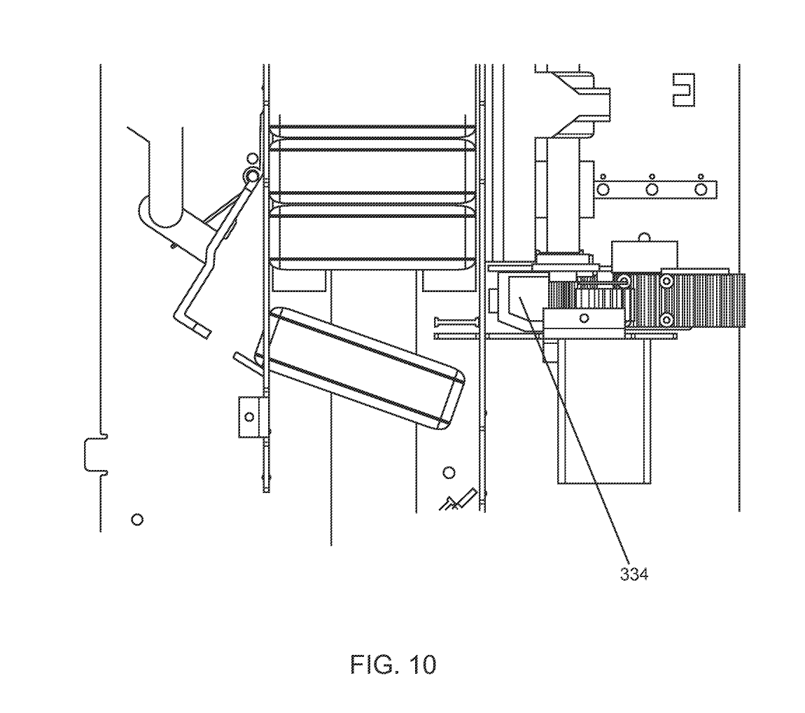

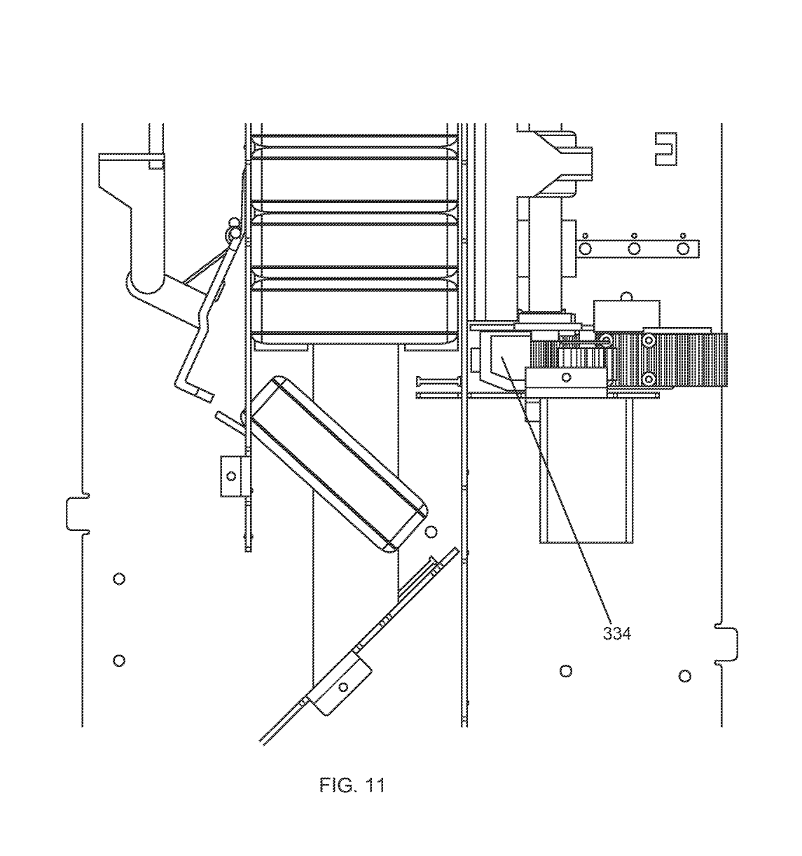

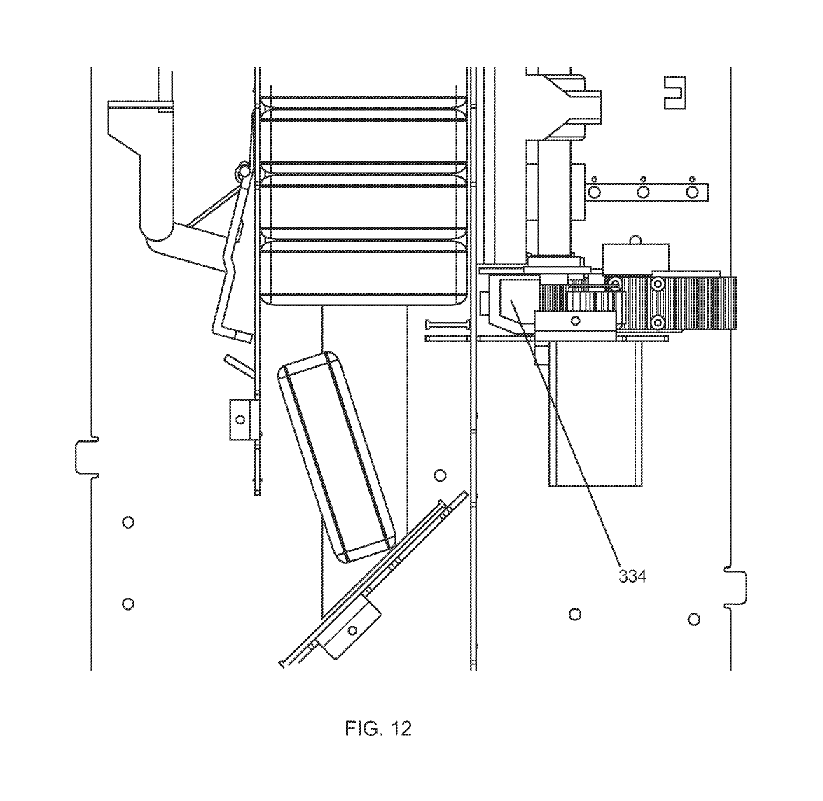

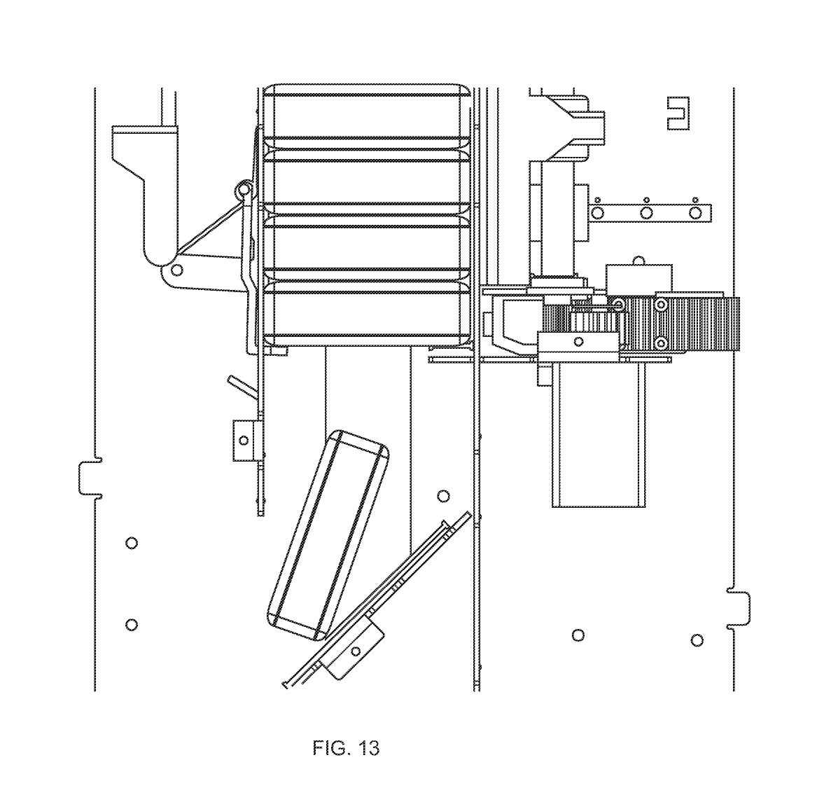

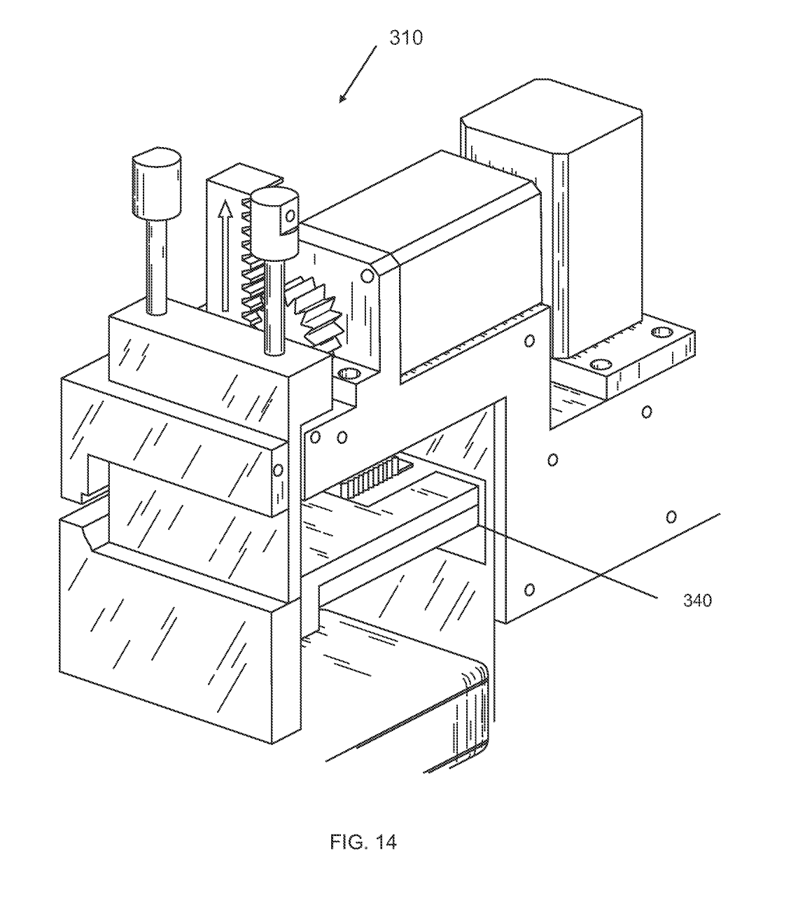

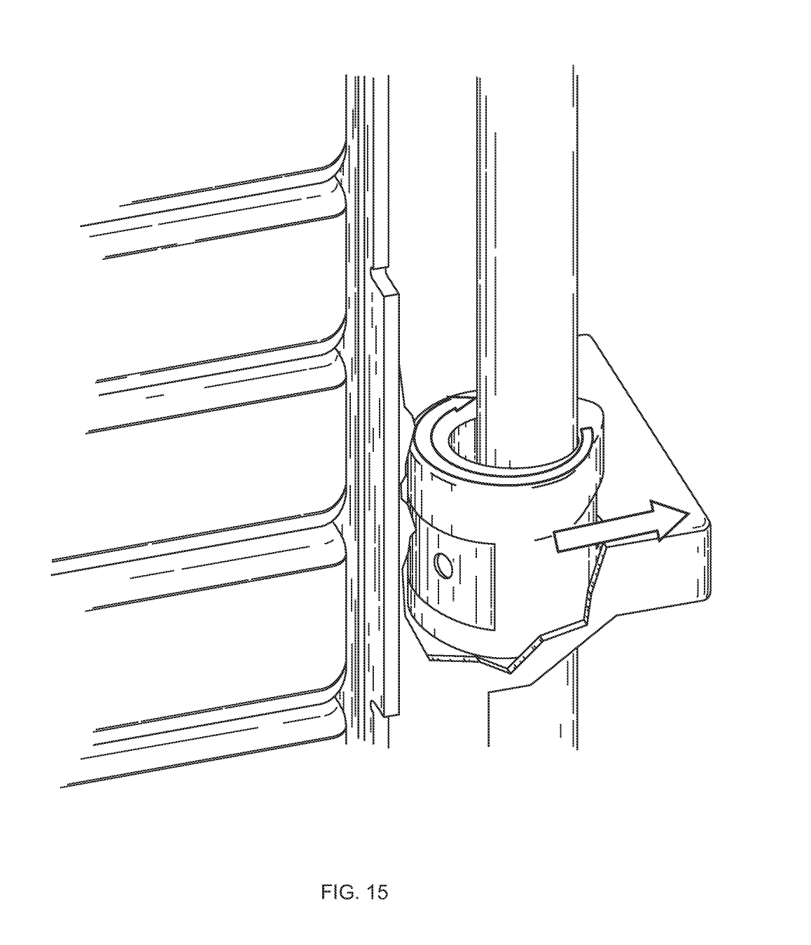

The kiosk (100) preferably comprises of at least one battery pack return slot (106), at least one battery pack (200) dispensing slot (104), a user interface (110), and a battery pack apparatus (300). The kiosk (100) may vary in size and shape depending on where it is intended to be used. In a preferred embodiment, shown in FIGS. 1-5, the kiosk (100) stands alone for maximum portability and ease of use. Alternatively, the kiosk (100) may be mounted to a wall, in a large display with multiple kiosks (100), or in any other suitable form. In a preferred embodiment, the dimensions of the kiosk (100) are 3.5 feet (1.1 z meters) by 2 feet (0.6 meters) by 1 foot (0.3 meters). The kiosk (100) may preferably include vacuum formed endcaps (102) to preferably seal the battery pack apparatus (300) within the kiosk (100). The kiosk (100) may also preferably include an illuminated header, an illuminated endcap (102), a means for receiving credit card information such as a bidirectional credit card reader/swiper (112), and a means for acquiring electricity to power said kiosk (100) from a vendor site. Such means preferably includes a 120 vacuum electrical connector (VAC) power connection. An embodiment of the invention is inclusion of a hinge in the front of the kiosk (100) that will serve as means of accessing the internal components of the kiosk (100). The kiosk (100) preferably includes means for communication with other kiosks (100) and network servers such as wireless connections, telephone connections, or Ethernet connections. Such means also preferably includes USB 3G/4G cellphone modem with an external antenna.

An embodiment of this invention includes the kiosk (100) have separate battery pack return (106) or battery pack dispensing slots (104) for each battery pack (200) with a particular connection including an Apple 30pin Connector (220), an Apple Lightning Connector, or a MicroUSB connection. Another embodiment of invention includes the kiosk (100) having three separate dispensing (104) and receiving slots (106) for each battery pack (200) with a particular connection including an Apple 30pin Connector (220), an Apple Lightning Connector, or a MicroUSB connection. Another embodiment of this invention will have a return mechanism for each of the charging mechanisms in place (3-10 total charging racks per kiosk (100)).

The user interface (110) preferably allows a user to interface with the kiosk (100), the kiosk software, and the battery pack apparatus (300). The user interface (110) is preferably a touchscreen (111) display on the front of the kiosk (100). The user interface (110) preferably comprises of user input, user interface screens (110), or advertising loop/animation. User input preferably includes the requirement for a user to touch the touchscreen (111) display to activate the kiosk (100), the requirement for the user to enter their email, the requirement for a user to agree to a user agreement, the requirement for the user to enter their credit card information, an option of the user to cancel the transaction, the option for the user to remove a battery pack (200) when dispensed, the option for a user to return a battery pack (200) the battery pack return slot (106). The user interface screens (110) preferably includes a home screen, a select battery type screen, an error screen due to lack of inventory, a user agreement screen, a modal window with a full user agreement text, a cancel transaction screen, an enter email for receipt screen, a please swipe credit card screen, a please place battery in return slot screen, and a thank you screen. The advertising loop/animation is preferably displayed when the kiosk (100) is not in use by a user.

The battery pack apparatus (300) preferably comprises of a carriage assembly (310), a battery chute/column, a bias plate charging mechanism (320), and a battery ejection mechanism. Another embodiment of the invention is that the battery pack apparatus (300) contains a battery dispenser (330). In this embodiment, the dispenser (330) may be of a columnar design or a modular chassis design. Also in this embodiment, the battery pack apparatus (300) may contains three dispensers (330). Each dispenser (330) preferably holds 15 to 25 battery packs (200). Each dispenser (330) is preferably disposed to hold a battery pack (200) with a particular connection including an Apple 30pin Connector (220), an Apple Lightning Connector, or a MicroUSB connection. Each dispenser (330) preferably comprises a means of dispensing battery packs (200) such as solenoid (332), linear actuator, or servo. The dispensing means preferably includes a block that is preferably extended in a normal state. When dispensing a battery pack (200), the block is preferably pulled back to allow battery pack (200) to fall into the area once occupied by the block. In order to dispense the battery, the block preferably extends and returns to its position in the normal state.

The carriage assembly (310) preferably further comprises a slider rod, carriage, carriage motor, a battery chute/rack, and a defective battery chute (328). A preferred embodiment of the invention is that the carriage assembly (310) has 3-15 battery chutes. The carriage assembly (310) may also further comprise of a trap door mechanism (322) and an RFID scanner (324). Another embodiment of the invention includes a bar code scanner (326) in the carriage assembly (310)

A user will preferably follow the user interface screens (110) to return a battery pack (200), at which point an access door will preferably open at the battery return slot (106). The carriage assembly (310) will preferably line up with the battery return slot (106) allowing a user to preferably insert the battery pack (200). The battery pack (200) and carriage assembly (310) will preferably be keyed in such a way to allow the battery pack (200) to be inserted in only one orientation. The orientation of insertion will preferably ensure positioning of the battery pack (200) for proper charging and proper sorting of the battery packs (200).

Upon insertion of the battery pack (200), the passive RFID tag (222) will be preferably scanned and the kiosk software will preferably process the data acquired from said scanning. The RFID scanner (324) will preferably either be incorporated into the carriage assembly (310) itself or be internally mounted in the kiosk (100).

Once the data processing has been completed, the carriage assembly (310) will preferably move to the appropriate battery chute where it will be deposited. The kiosk software will preferably include an algorithm to determine which battery chute out is best for the battery pack (200) to be deposited. If all of the chutes are at full capacity or if the pack needs to be removed from circulation, then the battery pack (200) will be preferably deposited in the Defective Battery Chute (328).

Once the battery pack (200) is inserted and requisite analysis by the kiosk software is completed, the carriage motor preferably drives the carriage across the slider rod to a predetermined position preferably above the battery chute or defective battery chute (328).

The trap door mechanism (322) will preferably include a quick fire spring-loaded solenoid mechanism, which will enable the battery pack (200) to fall in a balanced/square orientation.

In a preferred embodiment of the kiosk (100) will have a return mechanism for each of the charging mechanisms in place (3-10 total charging racks per kiosk (100)). The return mechanism consists of an insertion slot with a mechanical door, an insertion sensor, and a loading block (340) which allows for the battery pack (200) to fall into the charging rack. Each return mechanism preferably comprises a means of operating the mechanical door and release block such as solenoid, linear actuator, or servo. The loading means preferably includes a block that is preferably extended in a normal state. When loading a battery pack (200) into the charging mechanism, the block is preferably pulled back to allow battery pack (200) to fall into the area once occupied by the block.

The user selects return and will be directed to place the battery pack (200) on the forward facing external RFID reader (113). Kiosk software will process the battery pack (200) type and the user will be directed to place the battery pack (200) into the assigned return slot (106). The return slot door (106) will open and a LED (108) will be direct the customer. An internal sensor will be triggered causing the return slot door (106) to close.

The battery chutes will be preferably designed in a modular fashion. Each module will preferably have columns to hold battery packs (200). More preferably, each module will have three columns and each column will hold up to 25 battery packs (200). All battery pack (200) types are preferably compatible with each column.

The columns will preferably be gravity fed with the battery packs (200) being “dropped” from the carriage assembly (310) or return assembly at the top of the column. The columns will preferably include a means of reducing the impact forces of depositing a battery pack (200) from the top and it falling to the bottom of the column such as a tapered column that will slow the pack down as it moves to the bottom, a cushioned or spring loaded base plate, or a coating on the column walls that will ease the impact forces.

A bias plate charging mechanism (320) contains charging contacts/ports for each battery pack (200) will be preferably located at the rear of each column. The bias plate charging mechanism (320) also preferably includes a datum plate and a bias plate stepper motor. The charging points are preferably built into a printed circuit board assembly (PCBA) which is mounted to a metal plate. A 5 voltage direct current (VDC) bus bar preferably connects to each PCBA. The charging points are preferably made up of lithium ion smart charge circuits. The bias plate is preferably activated and preferably deactivated using a stepper motor and a cam bias system. The charging points are preferably spring loaded.

When the battery pack apparatus (300) is sitting idle, the bias plate (320) will be preferably activated/in the forward position and making contact with the battery packs (200) in order for charging.

The bias plate (320) will be preferably deactivated/in outward position when the battery pack apparatus (300) needs to dispense a battery to the customer or receive a battery from the carriage assembly (310). This deactivated state preferably enables the batteries in the column to drop down due to gravity without obstruction.

A single cam bias system will be preferably used for each three-column module. More preferably, one large system may be used for the entire battery pack apparatus (300) in order to cut cost.

Charging of the battery pack (200) will preferably not occur at the same time. The bias plate charging mechanism (320) will preferably rotate power supply to each of the column modules. The kiosk software will preferably include an algorithm to preferably determine when each column needs to be supplied power depending on the stock and battery residency times. This will preferably enable the system to have lower incoming power requirements from the wall outlet.

At the base of the bias plate (320) using the last charging contact points of the charging mechanism will be a sensor to determine the total capacity of the battery pack (200) that this located at this position. Kiosk software will determine if this capacity is at the appropriate amount before the battery pack (200) is dispensed.

The battery ejection mechanism preferably includes an ejector solenoid (332), an ejector plunger (334), and an ejector stepper motor. In order to dispense a battery pack (200), the bias plate (320) will be preferably deactivated. Once the bias plate (320) has been deactivated, the ejector Solenoid (332) will be preferably activated/extended. The ejector solenoid (332) is preferably connected to a hinged bracket (336) that extends into the column and preferably provides support for the battery pack (200) being dispensed during the ejection process. Once the ejector solenoid (332) is in its active state, the ejector stepper motor will preferably activate causing the ejector plunger (334) to retract. When the ejector plunger (334) is fully retracted, the battery pack (200) stacked within the column will preferably fall due to gravity. The hinged bracket (336) on the ejector solenoid (332) will preferably then “catch” the battery stack and preferably preventing it from falling any further. There will preferably be a plate under the ejector plunger (334) that will preferably serve to help “catch” the battery stack as well as preferably provide additional support for the plunger (334) when it is deactivated. At this point the lowest battery pack (200) in the column is preferably ready to be ejected. The second lowest battery pack (200) in the column is preferably now in the position that the lowest battery pack (200) was in when the process began. The ejector plunger (334) will preferably begin moving outward and the ejector solenoid (332) will be preferably deactivated. As the plunger (334) moves outward, the battery pack (200) to be dispensed will preferably and eventually get to the point where there is preferably little support holding it and the battery pack (200) will preferably fall down an ejection chute to the battery dispensing slot (104). The ejector plunger (334) can preferably extend to the full width of the battery chute. Once completed, the bias plate (320) will preferably be activated in order to restart the charging of the battery packs (200). One embodiment of this invention is that the hinge bracket (336) on the ejector solenoid (332) may be spring loaded in order to aid in the process. In another embodiment, the ejector plunger (334) only protrudes a third of the width of the battery chute.

Below the battery ejection mechanism will preferably be a method to store battery packs (200) that do not have the correct stored energy capacity as detected by the sensor at the base of the charging mechanism. This function ensures that only appropriately charged battery apparatuses are dispensed to the customer. Faulty battery packs (200) are stored in a holding area and retrieved at a later time by field personnel.

The kiosk software is preferably adapted with an architecture allowing for coordination between the battery pack (200), the battery pack apparatus (300), and the kiosk (100). The kiosk software is preferably written in Python, C++, or .NET and is preferably functional on both Windows and Ubuntu operating systems. The kiosk software is also preferably adapted for handling systems for battery pack (200) rental, battery pack purchase, battery pack return (106), kiosk monitoring, battery pack (200) management, payment gateway management, user management, on site kiosk (100) administration function, and basic hardware control.

For battery pack (200) purchase or rental, the kiosk software preferably works with the kiosk (100) and the battery pack apparatus (300). The kiosk software's processes in battery pack (200) rental preferably includes collecting a user's email information, means for contacting credit card processor for credit verification, logging a transaction identification marker with a particular transaction, logging a dispensed battery pack (200) RFID (222), storing processed data on network servers, and sending transaction details to the user by email. The kiosk software preferably has means of associating a transaction identification marker with a particular transaction. The kiosk software can preferably direct the battery pack apparatus (300) and kiosk (100) to activate sensors or initiate activation of battery pack (200) rotation/selection/processing. The kiosk software also preferably controls the user interface (110).

If a battery pack (200) is purchased then the unique RFID information (222) is stored and tied to the users profiles. Users who purchase will own the battery pack (200) and have the ability to recharge the purchased battery pack (200) on their own using a micro-usb cable. Additionally, users who purchased will be given the option to swap the purchased battery pack (200) for a fully charged battery pack (200) at any kiosk (100) location for a free or reduced price. The option to swap battery packs (200) for free or at a reduced price will offered on an unlimited basis for a set period of time.

For battery pack return, the kiosk software preferably works with the kiosk (100) and the battery pack apparatus (300). The kiosk software's processes in battery pack return preferably includes RFID processing, processing battery pack (200) location and state, storing processing data within network servers, processing credit charges associated with a particular transaction, submitting an email receipt of the transaction to the user. The kiosk software preferably has means of associating a transaction identification marker with a particular transaction. The kiosk software can preferably direct the battery pack apparatus (300) and kiosk (100) to initiate activation of battery pack (200) processing and placement. The kiosk software also preferably controls the user interface (110).

For kiosk monitoring, the kiosk software can preferably monitor the operating status of the kiosk (100), monitor network connection status, initiate remote diagnostics, push software updates, maintain an interaction log, and monitor the battery pack (200) inventory.

For battery pack management, the kiosk software can preferably monitor the battery pack (200) that are in circulation, monitor battery packs (200) that are in stock, engage administrative function to remove battery packs (200) from circulation, and create/maintain a log of battery pack (200) usage.

For payment gateway, the kiosk software can preferably store a transaction ID and process final payment.

For user management, the kiosk software can preferably maintain a user's information or email a reminder to a user to return the battery pack (200).

For on-site administration functions, the kiosk software can preferably remove battery packs (200) and log the removal, add battery packs (200) and log the additions, test communication, the credit card scanner (112), and test the passive RFID scanner (113). For basic hardware control, the kiosk software can preferably control the battery pack apparatuses' motors, and sensors/scanners (300). The kiosk software can also preferably control the kiosks doors (100) as well as preferably monitor the battery pack's voltage status.

PARTS LIST

| Part Number | Description |
|---|---|
| 100 | kiosk |
| 101 | pedestal |
| 102 | end cap |
| 103 | battery pack return sign |
| 104 | battery pack dispensing slot |
| 106 | battery pack return slots |
| 108 | LEDs |
| 110 | user interface |
| 111 | touchscreen |
| 112 | credit card swipe |
| 113 | RFID reader |
| 114 | end cap LED |
| 115 | Lock and Release Mechanism for Internal Access |
| 200 | battery pack |
| 210 | female micro-USB charging input |
| 212 | charge pads |
| 220 | Apple pin connector |
| 222 | RFID tag (not shown) |
| 224 | dielectric material (not shown) |
| 300 | battery pack apparatus |
| 310 | carriage assembly |
| 320 | bias plate charging mechanism |
| 322 | trap door mechanism |
| 324 | RFID scanner (not shown) |
| 326 | barcode scanner (not shown) |
| 328 | defective battery chute (not shown) |
| 330 | battery pack dispenser |
| 332 | solenoid |
| 334 | ejector plunge |
| 336 | hinged bracket |
| 340 | loading block |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. Apparatus for charging mobile devices comprising:
a) a battery pack;
b) a kiosk;
c) a battery pack apparatus for receiving, storing, charging, and dispensing, said battery pack; and
d) kiosk software.

2. The apparatus of claim 1, wherein the battery pack is adapted for general use on a broad range of mobile devices.

3-6. (canceled)

7. The apparatus of claim 1, wherein the battery pack includes one or more connectors.

8-12. (canceled)

13. The apparatus of claim 1, wherein the battery pack includes a barcode.

14. (canceled)

15. The apparatus of claim 1, wherein the kiosk comprises:
a. at least one battery pack return slot;
b. at least one battery pack dispensing slot; and
c. a user interface.

16. (canceled)

17. (canceled)

18. The apparatus of claim 15, wherein the kiosk further comprises a device for payment information.

19. (canceled)

20. The apparatus of claim 15, wherein the kiosk further comprises a communication device adapted to communicate with other kiosks and network servers.

21. The apparatus of claim 15, wherein the user interface comprises a touchscreen display.

22. The apparatus of claim 15, wherein the user interface comprises:
a. a user input device;
b. a user interface screen responsive to the user input device; and
c. an advertising display.

23. The apparatus of claim 1, wherein the battery pack apparatus comprises:
a. a carriage assembly;
b. a battery chute;
c. a bias plate charging mechanism operatively connected to the battery chute; and
d. a battery ejection mechanism operatively connected to the battery chute.

24. The apparatus of claim 23, wherein the carriage assembly includes one or more of the following:
a) a slider rod;
b) carriage;
c) carriage motor operatively positioned to move the carriage;
d) a defective battery chute;
e) a trap door release mechanism operatively connected to the battery chute and the defective battery chute;
f) an RFID scanner; and
g) a barcode scanner.

25-27. (canceled)

28. The apparatus of claim 24, wherein the battery chute comprises a column adapted to retain a plurality of battery packs.

29. (canceled)

30. The apparatus of claim 23, wherein the bias plate charging mechanism comprises:
a. a charging contact;
b. a datum plate; and
c. a bias plate stepper motor sufficient to urge the battery pack toward the charging contact.

31. (canceled)

32. The apparatus of claim 23, wherein the battery ejection mechanism comprises:
a. an ejector solenoid;
b. an ejector plunger operatively connected to the ejector solenoid; and
c. an ejector stepper motor.

33. The apparatus of claim 1, wherein the kiosk software is adapted for mechanical coordination between the battery pack, the battery pack apparatus, and the kiosk.

34. A method of using the apparatus of claim 1, comprising acquiring a battery pack for a fee to recharge mobile devices.

35. The method of claim 34 comprising the steps of:
a. entering data via the user interface;
b. processing the data entered via the user interface by the kiosk software processes the data entered by the individual;
c. selecting the proper battery pack for the individual; and
d. dispensing the battery pack to the individual.

36. The method of claim 35 further comprising:
e) trading in the battery pack for a fully charged battery pack at any kiosk in the kiosk network for free or at a reduced price.

37. (canceled)

38. The method of claim 35 further comprising:
e) returning the battery pack to any kiosk in the kiosk network and receiving a credit for part of the fee paid upon receipt of the battery pack.
